(19) United States
(12) Patent Application Publication
(10) Pub. No.: US 2011/0064335 A1
(43) Pub. Date: Mar. 17, 2011

(54) BAG WITH LINER

(76) Inventors: EGGO HASCHKE, DEERFIELD, IL (US); DENNIS NOLAN, ROME, GA (US)

(21) Appl. No.: 12/778,597

(22) Filed: May 12, 2010

Related U.S. Application Data
(60) Provisional application No. 61/298,819, filed on Jan. 27, 2010.
(60) Provisional application No. 61/295,565, filed on Jan. 15, 2010.
(60) Provisional application No. 61/177,543, filed on May 12, 2009.

(51) Int. Cl. B65D 30/08; B31B 1/62

(52) U.S. Cl. 383/109; 493/264

(57) ABSTRACT

A bag for encasing material is described. The bag comprises a sheet comprising a top panel, a bottom panel, an extended panel, a tear line separating the extended panel from the bottom panel, and a fold line separating the bottom panel from the top panel, the top panel being defined by a top border, a bottom edge, a bottom border, and the fold line, the bottom panel being defined by a top border, the fold line, a bottom border, and the tear line, and the extended panel being defined by a top border, the tear line, a bottom border, and a top edge; and a liner attached to a first side of the sheet and intersecting the fold line, the first side of the sheet being folded onto itself at the fold line, the top panel top edge being joined to the bottom panel top edge, and the top panel bottom edge being joined to the bottom panel bottom edge.

### CROSS-REFERENCE TO RELATED APPLICATIONS

This application claims priority from U.S. Provisional Patent Application No. 61/298,819, filed Jan. 27, 2010, from U.S. Provisional Patent Application No. 61/295,565, filed Jan. 15, 2010, and from U.S. Provisional Patent Application No. 61/177,543, filed May 12, 2009, the disclosure of each of which is incorporated herein.

### BACKGROUND OF THE INVENTION

This invention relates to the field of enclosing material in packaging material such as plastic bags, and in particular to bagging material such as dressed poultry, including by way of example and not by way of limitation, ducks, chickens, geese, turkeys, and other birds, both domestically raised and wild, both whole birds and cut-up parts. The invention will be described in connection with packaging whole chicken but is not limited to that application. A consumer can buy a whole dressed chicken in a grocery store, can buy one dressed chicken cut into parts, or can buy a package of for example, mixed parts or just legs or just wings. In the two latter situations, the chicken parts are usually placed on a disposable tray, typically made of a synthetic material such as the ones sold. as Styrofoam, in order to hold the parts together. Some poultry producers place whole dressed birds on these trays also.

One prior-art method to encase chickens is simply to place them manually in a plastic bag, to gather the mouth of the bag into a neck, and to apply a clip or other closing means to the neck of the bag. This method requires little capital investment. The bag must be large enough for the chicken to fit easily into the bag, however, which results in a loose appearance of the bag around the chicken. This appearance is dissatisfactory to some consumers, as well as requiring extra cost for larger bags

Another prior-art method to encase chickens is a heat-seal process. A whole chicken is placed in a plastic bag, the neck of the bag is clipped, and the package is then exposed to heat, shrinking the plastic around the chicken. Sometimes a clip is not used and the entire package is heat-sealed. An advantage to the heat-sealing process is that it wraps the product very tightly. In the case of products such as poultry, a tighter package presents a better appearance to consumers, so there is an increased marketing advantage to more tightly wrapped packages. Accordingly, the tighter the package can be wrapped, the more advantageous the system to poultry producers. This method, however, requires shrinkable bags, which are more expensive than other bags, as well as extra costs for energy and equipment for the shrinking part of the process. Additionally, if heat is not controlled precisely, too much heat will be applied and will overshrink the bag, causing holes to appear in the bag. Moreover, the plastic used in these types of applications tends to be somewhat brittle. Accordingly, rough handling in distribution or in, for example, a grocery store, can cause the bags to split open.

Yet another prior-art solution is to encase chicken in stretchable bags. The bag is stretched open, a chicken is pushed into the bag, and the bag is released, causing the bag to stretch tightly over the chicken. The neck of the bag is then clipped to close the package. This method is described in, for example, U.S. Pat. No. 6,895,726, Poly-stretch Bagger System, the disclosure of which is incorporated herein by reference.

It is conventional to place a whole dressed chicken in a bag shoulders or top end first, because placing the bottom end first is difficult. The legs tend to flop wide and prevent easy placement of a chicken in a bag bottom-first. Accordingly, producers tend to place a chicken in a bag top end first, under any of the methods described above. When a chicken is beheaded, however, the neck bones often have somewhat sharp edges or points. Accordingly, the neck bones tend to “pinch” or pierce the bottom of a bag regardless of which bagging method is used. A pierced bag will leak and will fail to seal the chicken from outside contamination. One partial solution is to sever the chicken's neck as closely as possible to the chest. This solution, however, cuts down on the yield, as chickens are commonly sold by weight and the closer the neck is severed to the chest, the less the dressed chicken will weigh.

The present invention addresses these problems. The present invention allows the consumer clearly to see the packaged contents of the bag and also allows for printing of trademarks, logos, and product information.

### BRIEF SUMMARY OF THE INVENTION

Briefly, and in accordance with the foregoing, the present invention in a first aspect is a bag for encasing material, the bag comprising a sheet comprising a top panel, a bottom panel, an extended panel, a tear line separating the extended panel from the bottom panel, and a fold line separating the bottom panel from the top panel, the top panel being defined by a top border, a bottom edge, a bottom border, and the fold line, the bottom panel being defined by a top border, the fold line, a bottom border, and the tear line, and the extended panel being defined by a top border, the tear line, a bottom border, and a top edge; and a liner attached to a first side of the sheet and intersecting the fold line, the first side of the sheet being folded onto itself at the fold line, the top panel top edge being joined to the bottom panel top edge, and the top panel bottom edge being joined to the bottom panel bottom edge. In another aspect, the present invention is a method of manufacturing the bag.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a plan view of the sheet from which the bag of the preferred embodiment of the present invention is made.

FIG. 2 is a perspective view of the bag made from the sheet of FIG. 1.

FIG. 3 is a diagrammatic cross-sectional view of the bag of FIG. 2.

FIG. 4 is a plan view of a sheet from which the bag of another embodiment of the present invention is made.

FIG. 5 is a perspective view of the bag made from the sheet of FIG. 4.

FIG. 6 is a diagrammatic cross-sectional view of the bag of FIG. 5.

FIG. 7 is a plan view of a sheet from which the bag of yet another embodiment of the present invention is made.

FIG. 8 is a perspective view of the bag of FIG. 7.

FIG. 9 is a diagrammatic cross-sectional view of the bag of FIG. 8.

FIG. 10 is a top view of two strips being formed into the bag of FIG. 8.

FIG. 11 is a top view of a two strips being formed into the bag of FIG. 8 by another embodiment.

FIG. 12 is a diagrammatic view of a method of manufacture of the bags of the present invention.

FIG. 13 is a diagrammatic view of another method of manufacture of the bags of the present invention.

### DETAILED DESCRIPTION OF THE PREFERRED EMBODIMENTS OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

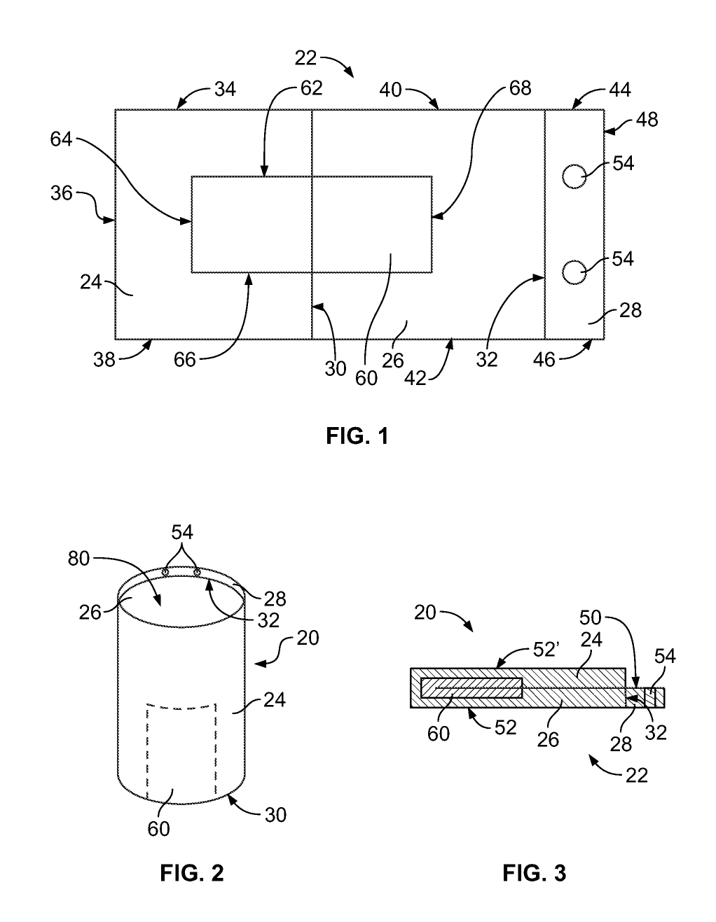

The bag 20 of the preferred embodiment of the present invention is made from a sheet 22 of plastic film, as shown in FIG. 1. Preferably, a memory agent has been added to the plastic film. The use of polyethylene film with three to ten percent ethylene vinyl acetate (EVA) has been found to provide the best memory and therefore the least distortion of printed matter. Other plastics and other memory agents are used as well. In the preferred embodiment, sheet 22 is 1.5 mils thick (0.0015 inch). Other thicknesses can be used as well.

Sheet 22 is divided into three panels, a top panel 24, a bottom panel 26, and an extended panel 28, by fold line 30 and perforated tear line 32. Top panel 24 is defined by top border 34, bottom edge 36, bottom border 38, and fold line 30. Bottom panel 26, preferably identical in size to top panel 24, is defined by top border 40, fold line 30, bottom border 42, and tear line 32. Extended panel 28 is defined by top border 44, tear line 32, bottom border 46, and top edge 48. Sheet 22 has a top side 50 and an opposite, bottom side 52. Preferably, top panel 24 is identical in size and shape to bottom panel 26.

Liner sheet 60 is attached to top side 50. Liner sheet 60 is defined by top border 62, bottom edge 64, bottom border 66, and top edge 68. Liner sheet 60 is preferably made of the same material as sheet 22, preferably 1.5 mil polyethylene with memory agent as described above. In other embodiments, other thicknesses of liner 60 are used, either thinner than sheet 22 or thicker than sheet 22. In yet other embodiments, liner sheet 60 is made of different plastic than the plastic of sheet 22. In some embodiments, liner sheet 60 is made without memory agent.

Liner sheet 60 is attached to sheet 22 by heat, ultrasonic welding, glue or other adhesive, or other attachment means. Liner sheet 60 is preferably centered horizontally (as illustrated) on fold line 30 and is preferably centered vertically (as illustrated) between top borders 34, 40 and bottom borders 38, 42. Liner sheet 60 need not be centered on fold line 30, however, so long as it intersects fold line 30. There must be enough of line 60 on top panel 24 and bottom panel 26 to protect what will become the bottom of bag 20 from sharp neck bones. Liner 60 could extend to the limits of sheet 22, so that top border 62 is coextensive with top panel top border 34 and bottom panel top border 40, and/or bottom border 66 is coextensive with top panel bottom border 38 and bottom panel bottom border 42.

Liner sheet 60 is preferably formed in a shape similar to sheet 22, as illustrated, rectangular. Liner 60, however, in other embodiments has other shapes, including by way of illustration and not by way of limitation, square, round, and oval.

Top side 50 of sheet 22 is folded onto itself at fold line 30, top panel top border 34 is joined to bottom panel top border 40 and top panel bottom border 38 is joined to bottom panel bottom border 42, by heat, ultrasonic welding, glue or other adhesive, or other suitable joining means. Bag 20 is therefore formed, having, when opened, a mouth 80 defined by what was top panel bottom edge 36 and tear line 30.

Extended panel 28 preferably has two wicket holes 54 for placement on a wicket as described in the '726 patent. In use, bag 50 is torn away from extended panel 26 at tear line 32, which is preferably perforated for easy separation.

Bag 20 is shown in perspective view in FIG. 2 as open for use, with liner sheet 60 shown in dotted lines. Bag 20 is shown in diagrammatic, cross-sectional elevation view in FIG. 3, as a bag would appear if stacked on a wicket.

In other embodiments, extended panel 28 does not have holes 54. In yet other embodiments, sheet 22 does not have extended panel 28.

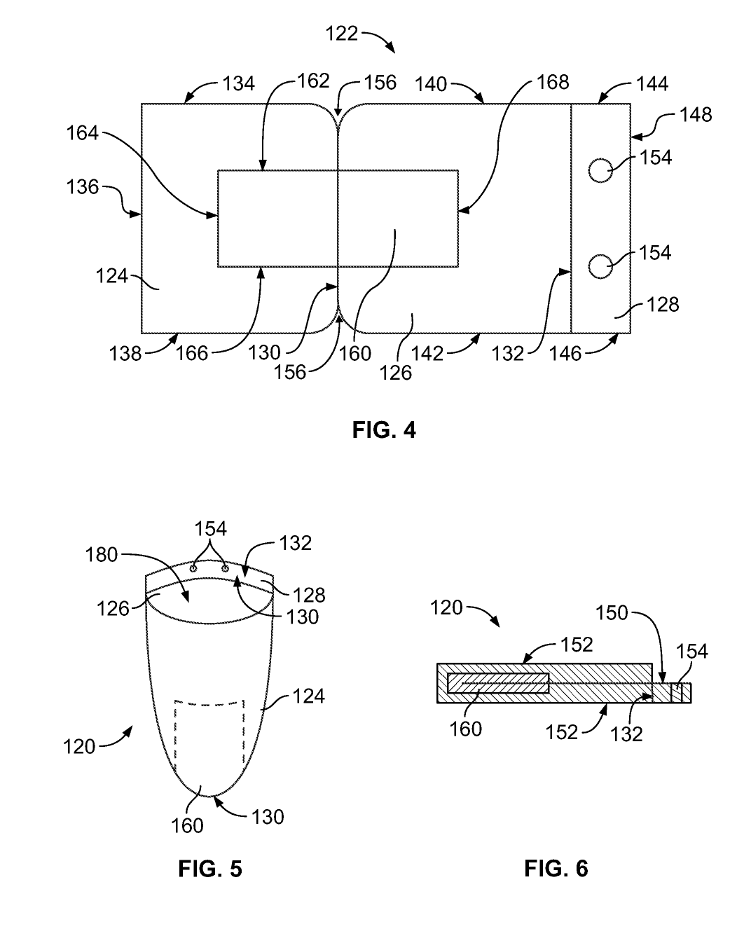

Another embodiment of a bag 120 of another embodiment of the invention is made from sheet 122, as illustrated in FIG. 4. Sheet 122 is divided into three panels, a top panel 124, a bottom panel 126, and an extended panel 128, by fold line 130 and perforated tear line 132. Sheet 122 is made from the same material as described above for sheet 22. In this embodiment, however, there are notches 156 in sheet 122, centered on fold line 130. Notches 156 can be cut from sheet 122 before folding, or after folding, or even after joining.

Top panel 124 is defined by top border 134, bottom edge 136, bottom border 138, and fold line 130. In this embodiment, however, top panel top border 134 and top panel bottom border 138 are arcuate or inset at their ends closest to fold line 130. Bottom panel 126, preferably identical in size to top panel 124, is defined by top border 140, fold line 130, bottom border 142, and tear line 132. In this embodiment, however, bottom panel top border 140 and bottom panel bottom border 142 are arcuate or inset at their ends closest to fold line 130. Preferably, top panel 124 is identical in size and shape to bottom panel 126.

Extended panel 128 is defined by top border 144, tear line 132, bottom border 146, and top edge 148. Sheet 122 has a top side 150 and an opposite, bottom side 152.

In the preferred embodiment, notches 156 have two arcuate sides, so that bag 120, when formed, will have a rounded bottom. In other embodiments, notches 156 have straight sides, with top panel top border 134, top panel bottom border 138, top panel bottom border 138, and bottom panel bottom border 142 having inset configurations, so that bag 120 has a tapered appearance. Notches 156 can be of other shapes and configurations. Notches 156 preferably do not extend into liner 160. In other embodiments, notches 156 extend to or into liner 160. Liner sheet 160 is attached to top side 150. Liner sheet 160 is defined by top border 162, bottom edge 164, bottom border 166, and top edge 168. Liner sheet 160 is preferably made of the same material as sheet 122, preferably 1.5 mil polyethylene with memory agent as described above. In other embodiments, other thicknesses of liner 160 are used, either thinner than sheet 122 or thicker than sheet 122. In yet other embodiments, liner 160 is made of different plastic than the plastic of sheet 122. In some embodiments, liner sheet 160 is made without memory agent. In some embodiments, liner 160 extends all the way to notches 156.

Liner sheet 160 is attached to sheet 122 by heat, ultrasonic welding, glue or other adhesive, or other attachment means. Liner sheet 160 is preferably centered horizontally (as illustrated) on fold line 130 and is preferably centered vertically (as illustrated) between top borders 134, 140 and bottom borders 138, 142. Liner sheet 160 need not be centered on fold line 130, however, so long as it intersects fold line 130. There must be enough of line 160 on top panel 124 and bottom panel 126 to protect what will become the bottom of bag 120 from sharp neck bones.

Liner sheet 160 is preferably formed in a shape similar to sheet 122, as illustrated, rectangular. Liner 160, however, in other embodiments has other shapes, including by way of illustration and not by way of limitation, square, round, and oval.

Top side 150 of sheet 122 is folded onto itself at fold line 130, top panel top border 134 is joined to bottom panel top border 140 and top panel bottom border 138 is joined to bottom panel bottom border 142, by heat, ultrasonic welding, glue or other adhesive, or other suitable sealing means. Bag 120 is therefore formed, having, when opened, a mouth 180 defined by what was top panel bottom edge 136 and tear line 130.

Extended panel 126 generally has two wicket holes 154 for placement on a wicket as described in the '726 patent. In use, bag 120 is torn away from extended panel 128 at tear line 132.

Bag 120 is shown in perspective view in FIG. 5 as open for use, with liner sheet 160 shown in dotted lines. Bag 120 is shown in diagrammatic, cross-sectional elevation view in FIG. 6, as a bag would appear if stacked on a wicket. In other embodiments, extended panel 128 does not have holes 154. In yet other embodiments, sheet 122 does not have extended panel 128.

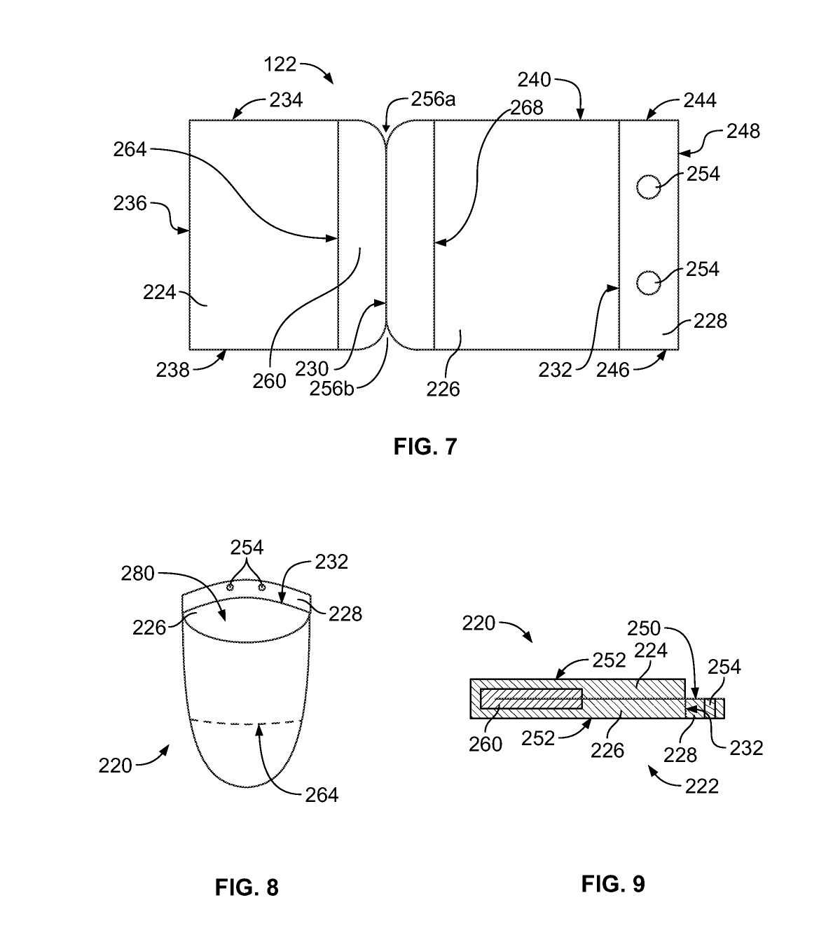

Another bag 220 of yet another embodiment of the invention is made from sheet 222, as illustrated in FIG. 7. Sheet 222 is divided into three panels, a top panel 224, a bottom panel 226, and an extended panel 228, by fold line 230 and perforated tear line 232. Sheet 222 is made from the same material as described above for sheet 22. In this embodiment, however, there are notches 256A and 256B in sheet 222, centered on fold line 230. Notches 256 can be cut from sheet 222 before folding, or after folding, or even after joining.

Top panel 224 is defined by top border 234, bottom edge 236, bottom border 238, and fold line 230. In this embodiment, however, top panel top border 234 and top panel bottom border 238 are arcuate at their ends closest to fold line 230, because of notches 256A and 256B.

Bottom panel 226, preferably identical in size to top panel 224, is defined by top border 240, fold line 230, bottom border 242, and tear line 232. In this embodiment, however, bottom panel top border 240 and bottom panel bottom border 242 are arcuate at their ends closest to fold line 230, because of notches 256A and 256B. Preferably, top panel 224 is identical in size and shape to bottom panel 226.

Extended panel 228 is defined by top border 244, tear line 232, bottom border 246, and top edge 248. Sheet 222 has a top side 250 and an opposite, bottom side 252.

In the preferred embodiment, notches 256A, 256B have two arcuate sides, so that bag 220, when formed, will have a rounded bottom. In the preferred embodiment, notches 256 have two arcuate sides, so that bag 220, when formed, will have a rounded bottom. In other embodiments, notches 256 have straight sides, with top panel top border 234, top panel bottom border 238, top panel bottom border 238, and bottom panel bottom border 242 having inset configurations, so that bag 220 has a tapered appearance. Notches 256 can be of other shapes and configurations. Notches 256 preferably do not extend into liner 260. In other embodiments, notches 256 extend to or into liner 260.

Liner sheet 260 is attached to top side 250. Liner sheet 260 is defined by bottom edge 264, top edge 268, and by notches 256A and 256B. Liner sheet 260 is preferably made of the same material as sheet 222, preferably 1.5 mil polyethylene with memory agent as described above. In other embodiments, other thicknesses of liner 260 are used, either thinner than sheet 222 or thicker than sheet 222. In yet other embodiments, liner 260 is made of different plastic than the plastic of sheet 222. In some embodiments, liner sheet 260 is made without memory agent.

Liner sheet 260 is attached to sheet 222 by heat, ultrasonic welding, glue or other adhesive, or other attachment means. Liner sheet 260 is preferably centered horizontally (as illustrated) on fold line 230 and is preferably centered vertically (as illustrated) between top borders 234, 240 and bottom borders 238, 242. Liner sheet 260 need not be centered on fold line 230, however, so long as it intersects fold line 230. There must be enough of line 260 on top panel 224 and bottom panel 226 to protect what will become the bottom of bag 220 from sharp neck bones.

Liner sheet 260 is preferably formed in a shape similar to sheet 222, as illustrated, generally rectangular but with notches 256A, 256B forming V-shapes on either end. Liner 260, however, in other embodiments has other shapes, including by way of illustration and not by way of limitation, square, round, and oval.

Top side 250 of sheet 222 is folded onto itself at fold line 230, top panel top border 234 is joined to bottom panel top border 240 and top panel bottom border 238 is joined to bottom panel bottom border 242, by heat, ultrasonic welding, glue or other adhesive, or other suitable sealing means. Bag 220 is therefore formed, having, when open, a mouth 280 defined by what was bottom panel bottom border 240 and tear line 230, as shown in FIG. 5.

Extended panel 226 generally has two wicket holes 254 for placement on a wicket as described in the '726 patent. In use, bag 220 is torn away from extended panel 226 at tear line 232.

Bag 220 is shown in perspective view in FIG. 5 as open for use, with liner sheet 260 shown in dotted lines. Bag 220 is shown in diagrammatic, cross-sectional elevation view in FIG. 9, as a bag would appear if stacked on a wicket.

In other embodiments, extended panel 228 does not have holes 254. In yet other embodiments, sheet 222 does not have extended panel 228.

An exemplar method of manufacturing bag 220 will now be described. A strip 320 of bag material, preferably polyethylene, preferably seven inches wide, has notches 256A, 256B cut out of it. Notches 256A, 256B center on fold line 230. Notches 256A, 256b are preferably cut by a rotary die cutter. Then, strip 320 is intersected at a right angle by a cross-strip 322 of liner material, preferably polyethylene, preferably four inches wide. Both strip 320 and cross-strip 322 are supplied on a spool. Strip 320 and cross-strip 322 preferably contain three to ten percent ethylene vinyl acetate (EVA), most preferably in excess of eight percent EVA. Strip 320 is preferably 2.0 mil and cross-strip 322 is preferably 1.7 mil.

In one embodiment, cross-strip 322 is merely set on top of strip 320. Strip 320 is then folded at fold line 230, causing cross-strip 322 to fold as well. Notches 256A, 256B are then cut from cross-strip 322 and the borders are then welded to form bag 220.

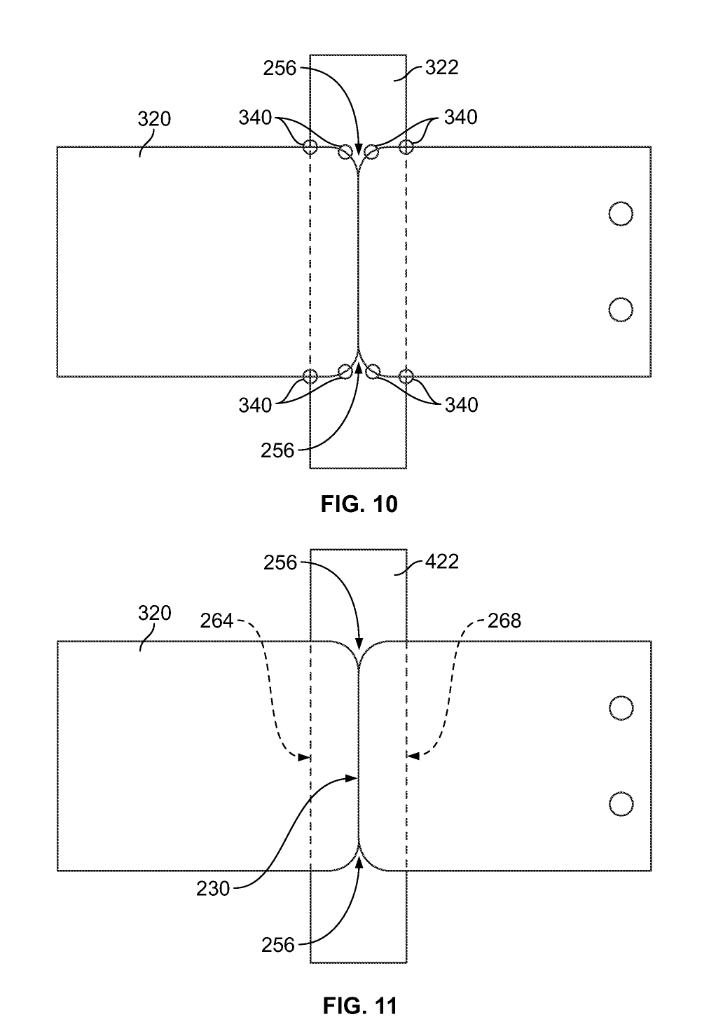

In another embodiment, cross strip 322, after being set on strip 320, is tack-welded to strip 320 at points 340, shown in circles in FIG. 10. Strip 320 is then folded at fold line 230, causing cross-strip 322 to fold as well. Notches 256A, 256B are then cut from cross-strip 322 and the borders are then welded to form bag 220.

Another method of manufacturing bag 220 will now be described. A strip 320 of bag material, preferably polyethylene, preferably seven inches wide, has notches 256A, 256B cut out of it, as shown in FIG. 7. Notches 256A, 256B center on fold line 230. Notches 256A, 256b are preferably cut by a rotary die cutter. Then, strip 320 is intersected at a right angle by a cross-strip of tape 422, as shown in FIG. 11. Tape 422 is a plastic material, preferably polyethylene, preferably four inches wide, to which an adhesive has been applied. Since tape 422 will become bag liner 260, tape 422 must be approved for food contact by the local authorities where bag 220 will be used, if bag 220 will be used for poultry or other food products. Accordingly, the adhesive on tape 422 is preferably a commercially-available adhesive approved for food contact by the United States Food and Drug Administration and the United States Department of Agriculture.

Both strip 320 and tape 422 are preferably supplied on a spool. Strip 320 and tape 422 preferably contain three to ten percent ethylene vinyl acetate (EVA), most preferably in excess of eight percent EVA. Strip 320 is preferably 2.0 mil and tape 422 is preferably 1.7 mil.

Tape 422 is adhered to the top of strip 320. The adhesive of tape 422 causes tape 422 to adhere to strip 320. Strip 320 is then folded at fold line 230, causing tape 422 to fold as well. Notches 256A, 256B are then cut from tape 422 as described above and the borders are then welded to form bag 220 as described above. Tape 422 becomes bag line 260.

In yet another embodiment, tape is applied to form a liner sheet of a bag. This method can be used to form bag 20 with liner sheet 60, bag 120 with liner sheet 160, or bag 220 with liner sheet 260. The method will be described in connection with manufacture of bag 120, but can be used as well to manufacture bags of other embodiments.

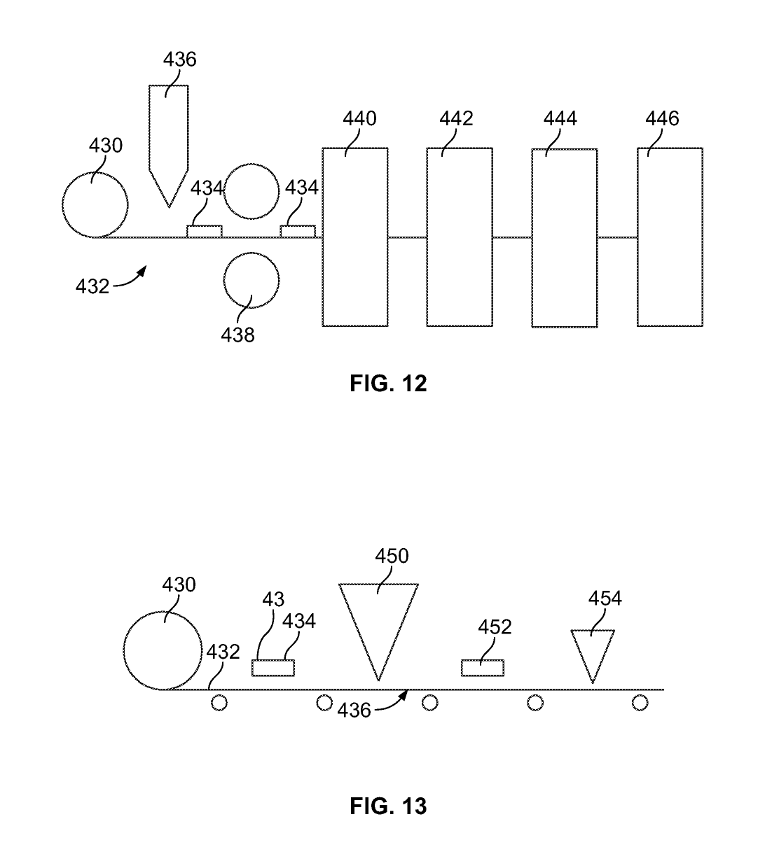

In this method, a roll 430 of plastic film 432 is unwound, as shown in FIG. 12. Preferably, plastic film 432 contains a memory agent. The use of polyethylene film with three to 10 percent ethylene vinyl acetate (EVA) has been found to provide the best memory and therefore the least distortion of printed matter. Other plastics and other memory agents are used as well. In the preferred embodiment, plastic film 432 is 1.5 mils thick (0.0015 inch). Other thicknesses can be used as well.

Film 432 then has a piece of pressure-sensitive tape 434 applied to the top side 436 of film 432. Preferably, tape 434 is a rectangle, three inches long by 1.5 inches wide. Tape 434 is a plastic material, preferably polyethylene, to which an adhesive has been applied. Since tape 434 will become bag liner 160, tape 434 must be approved for food contact by the local authorities where bag 120 will be used, if bag 120 will be used for poultry or other food products. Accordingly, the adhesive on tape 434 is preferably a commercially-available adhesive approved for food contact by the United States Food and Drug Administration and the United States Department of Agriculture.

Tape 434 is preferably applied to film 432 by label applicator 436. Since tape 434 is preferably pressure-sensitive, tape 434 can be applied to film 432 by marrying rollers in a manner well-known in the art. Other means of applying tape 434 to film 432 can be used. Film 432 then proceeds through die cutter 438, which cuts notches 156 and wicket holes 152 into film 432. Film 432 then proceeds to cutter 440, which transversely cuts film 432 to form bottom edge 136 of leading sheet 122 and top edge 148 of trailing sheet 122.

Each individual sheet 122 then proceeds to folder 442, which turns sheet 122 over on fold line 130. Each folded sheet 122 then proceeds to welder 444, where top border 134 is ultrasonically welded to top border 140 and bottom border 138 is ultrasonically welded to bottom border 142, to form bag 120. Each individual bag 120 proceeds to stacker 446 where a plurality of bags 120 are stacked and a wicket is placed in wicket holes 154.

An individual bag 120 manufactured in this manner is as shown in cross-section in FIG. 6, in which tape 434 becomes bag liner 160.

Yet another embodiment is shown in FIG. 13. In this method, a roll 430 of plastic film 432 is unwound, as shown in FIG. 13. Plastic film 432 contains a memory agent as described above. Film 432 then has tape 434 applied to the top side 436 of film 432 by label applicator 438. As described above, the adhesive on tape 434 is preferably a commercially-available adhesive approved for food contact by the United States Food and Drug Administration and the United States Department of Agriculture. Film 432 then proceeds through folder 450, which folds film 432 at fold line 130. Folded film 432 then proceeds to cutter 452, which cuts notches 156 to form a round bottom. Film 432 then proceeds to cutter sealer 454, which seals top border 134 to top border 140 and bottom border 138 to bottom border 142, to form bag 120. Sealer 454 can use ultrasonic sealing, gluing, or some other means of joining plastic edges. Each individual bag 120 proceeds to stacking as described above.

An individual bag 120 manufactured in this manner is as shown in cross-section in FIG. 6, in which tape 434 becomes bag liner 160.

While preferred embodiments of the present invention are shown and described, it is envisioned that those skilled in the art may devise various modifications of the present invention without departing from the spirit and scope of the appended claims.

We claim:

1. A bag for encasing material, the bag comprising:
a sheet comprising a top panel, a bottom panel, an extended panel, a tear line separating the extended panel from the bottom panel, and a fold line separating the bottom panel from the top panel,
the top panel being defined by a top border, a bottom edge, a bottom border, and the fold line, the bottom panel being defined by a top border, the fold line, a bottom border, and the tear line, and the extended panel being defined by a top border, the tear line, a bottom border, and a top edge; and
a liner attached to a first side of the sheet and intersecting the fold line;
the first side of the sheet being folded onto itself at the fold line, the top panel top edge being joined to the bottom panel top edge, and the top panel bottom edge being joined to the bottom panel bottom edge.

2. The bag of claim 1, further comprising notches in the sheet, whereby at least a portion of the top panel top border, the top panel bottom border, the bottom panel top border, and the bottom panel bottom border are one of arcuate and inset.

3. The bag of claim 1, said sheet comprising polyethylene.

4. The bag of claim 3, said sheet comprising memory agent.

5. The bag of claim 4, said liner comprising polyethylene.

6. The bag of claim 5, said liner comprising memory agent.

7. The bag of claim 1, further comprising holes in said extended panel.

8. The bag of claim 1, wherein said tear line is perforated.

9. A bag for encasing materials, the bag comprising:
a top panel defined by a top border, a bottom edge, a bottom border, and a fold line;
a bottom panel defined by a top border, the fold line, a bottom border, and a tear line, the bottom panel top border being joined to the top panel top border and the bottom panel bottom border being joined to the top panel bottom border; and
a liner joined to a first side of the top panel and to a first side of the bottom panel, the top panel first side and the bottom panel first side being adjacent, the liner intersecting the fold line.

10. The bag of claim 9, further comprising an extended panel defined by a top border, a bottom border, a top edge, and the tear line.

11. The bag of claim 10, further comprising holes in said extended panel.

12. The bag of claim 9, said sheet comprising polyethylene.

13. The bag of claim 12, said sheet comprising memory agent.

14. The bag of claim 9, said liner comprising polyethylene.

15. The bag of claim 14, said liner comprising memory agent.

16. The bag of claim 9, wherein at least a portion of the top panel top border, the top panel bottom border, the bottom panel top border, and the bottom panel bottom border are one of arcuate and inset.

17. A method of manufacturing a bag for encasing material, the method comprising the steps of:
applying a strip of adhesive tape to a strip of film;
transversely cutting the strip of film to form a sheet, the sheet comprising a top panel and a bottom panel, the top panel separated from the bottom panel by a fold line, the strip of adhesive tape intersecting the fold line; and
joining a top border of the top panel to a top border of the bottom panel and joining a bottom border of the top panel to a bottom border of the bottom panel.

18. The method of claim 17, further comprising cutting notches in one of the strip of film and the sheet.

19. The method of claim 17, wherein the sheet further comprises an extended panel, the extended panel separated from the bottom panel by a tear line.

20. The method of claim 17, wherein at least one of the strip of film and the strip of adhesive tape comprise polyethylene and memory agent.
